(19) United States
(12) Patent Application Publication
(10) Pub. No.: US 2024/0419768 A1
(43) Pub. Date: Dec. 19, 2024

(54) CONTROLLING DISPLAY SCREEN INTERACTION BASED ON FINGERPRINT INFORMATION AND FORCE INFORMATION

(71) Applicant: QUALCOMM Incorporated, San Diego, CA (US)

(72) Inventor: Gordon THOMAS, Encinitas, CA (US)

(21) Appl. No.: 18/335,808

(22) Filed: Jun. 15, 2023

(51) Int. Cl. G06F 21/32; G06F 3/041; G06V 40/12; G06V 40/13

(52) U.S. Cl. CPC G06F 21/32; G06F 3/0414; G06V 40/1306; G06V 40/1365; G06F 2203/04105

(57) ABSTRACT

Various aspects of the present disclosure generally relate to user devices. In some aspects, a user device may generate, using a fingerprint sensor of the user device, fingerprint information associated with a finger press of a user of the user device. The user device may authenticate the user in association with the fingerprint information. The user device may determine, in association with force information generated by a force sensor of the user device, an amount of force applied to a display screen of the user device by the finger press. The user device may perform, in association with authenticating the user, an action that is associated with the amount of force applied to the display screen. Numerous other aspects are described.

### FIELD OF THE DISCLOSURE

Aspects of the present disclosure generally relate to user devices and, for example, to control of display screen interactions with a user device.

### BACKGROUND

A user device may include a display screen. The display screen may be an output device for presentation of information in visual form. For example, the display screen may include an output surface and a projecting mechanism that displays text and/or graphic images using a cathode ray tube (CRT), a liquid crystal display (LCD), a light-emitting diode (LED) display, an organic LED (OLED) display, a gas plasma display, or another image projection technology. In some cases, the display screen may also function as an input device. For example, the display screen may be touch-sensitive, which enables a user to interact with the user device through tough interactions with the display screen.

### SUMMARY

Some aspects described herein relate to a user device. The user device may include one or more memories and one or more processors coupled to the one or more memories. The one or more processors may be configured to generate, using a fingerprint sensor of the user device, fingerprint information associated with a finger press of a user of the user device. The one or more processors may be configured to authenticate the user in association with the fingerprint information. The one or more processors may be configured to determine, in association with force information generated by a force sensor of the user device, an amount of force applied to a display screen of the user device by the finger press. The one or more processors may be configured to perform, in association with authenticating the user, an action that is associated with the amount of force applied to the display screen.

Some aspects described herein relate to a method performed by a user device. The method may include generating, using a fingerprint sensor of the user device, fingerprint information associated with a finger press of a user of the user device. The method may include authenticating the user in association with the fingerprint information. The method may include determining, in association with force information generated by a force sensor of the user device, an amount of force applied to a display screen of the user device by the finger press. The method may include performing, in association with authenticating the user, an action that is associated with the amount of force applied to the display screen.

Some aspects described herein relate to a non-transitory computer-readable medium that stores a set of instructions. The set of instructions, when executed by one or more processors of a user device, may cause the user device to generate, using a fingerprint sensor of the user device, fingerprint information associated with a finger press of a user of the user device. The set of instructions, when executed by one or more processors of the user device, may cause the user device to authenticate the user in association with the fingerprint information. The set of instructions, when executed by one or more processors of the user device, may cause the user device to determine, in association with force information generated by a force sensor of the user device, an amount of force applied to a display screen of the user device by the finger press. The set of instructions, when executed by one or more processors of the user device, may cause the user device to perform, in association with authenticating the user, an action that is associated with the amount of force applied to the display screen.

Some aspects described herein relate to an apparatus. The apparatus may include means for generating, using a fingerprint sensor of the apparatus, fingerprint information associated with a finger press of a user of the apparatus. The apparatus may include means for authenticating the user in association with the fingerprint information. The apparatus may include means for determining, in association with force information generated by a force sensor of the apparatus, an amount of force applied to a display screen of the apparatus by the finger press. The apparatus may include means for performing, in association with authenticating the user, an action that is associated with the amount of force applied to the display screen.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIGS. 3A and 3B are diagrams illustrating an example associated with a touch-enabled display device, in accordance with the present disclosure.

FIGS. 4A-4D are diagrams illustrating examples associated with controlling a display screen interaction based on fingerprint information and force information, in accordance with the present disclosure.

FIG. 5 is a flowchart of an example process associated with controlling a display screen interaction based on fingerprint information and force information.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A user device may include a display screen for presenting visual content to a user. In some cases, the display screen may also function as an input device. For example, the display screen may be touch-sensitive, which enables a user to interact with the user device through tough interactions with the display screen. In some cases, a user device may be configured to obtain fingerprint information from a user to authenticate the user. The user device may transition the display screen from a first lock mode (e.g., locked) to a second mode (e.g., unlocked) and/or vice versa based on authenticating the user.

While authenticating the user may provide increased security for the user device and the user's information, some user information may still be displayed prior to authentication of the user. For example, message notifications displayed on a lock screen of the user device may result in user information (e.g., message contents, message sender information) being displayed prior to authentication of the user, allowing unauthorized users to potentially access the user information.

In some implementations described herein, a user device may control access to user information and/or user interface settings based on and/or otherwise in association with an amount of force applied to a display screen of the user device by a finger press of a user of the user device. The user device may refrain from displaying user information and/or may refrain from providing access to user interface settings until the user provides a finger press for authenticating the user based on and/or otherwise in association with fingerprint information obtained from the finger press. Only then does the user device display the user information and/or user interface settings, and the amount of force applied by the finger press to the display screen may be used to provide more granular control over interactions with the user information and/or user interface settings. For example, if a first amount of force is applied to the display screen by the finger press, the user device may perform a first action (e.g., displaying a preview of a message notification, toggling a user interface setting), whereas the user device may perform a second action (e.g., opening a messaging application, displaying individual parameters associated with a user interface setting) if a second amount of force is applied to the display screen by the finger press.

Some implementations described herein enable secure access to user information and/or user interface settings of a user device using fingerprint-based authentication, which may provide faster user authentication than other types of authentication such as password-based authentication or personal identification number (PIN)-based authentication. Fingerprint-based authentication may require fewer inputs or interactions with the display screen of the user device than other types of user authentication, which may reduce the consumption of user device resources (e.g., battery resources, processing resources, memory resources) because the user device does not need to display and process additional inputs for passwords or PINs.

Moreover, some implementations described herein provide improved user experience for the user of the user device in that the user may intuitively access user information in various ways and/or may intuitively fine-tune user interface settings and/or associated parameters by adjusting the amount of force applied to the display screen of the user device. This also may reduce the consumption of user device resources (e.g., battery resources, processing resources, memory resources) because the user may perform fewer presses or interactions to access particular user information and/or to modify a user interface setting.

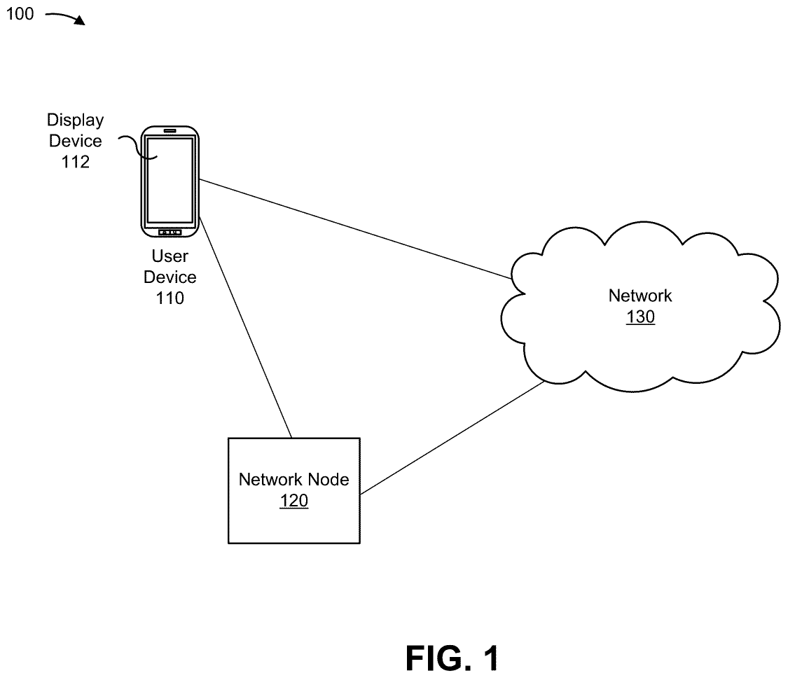

FIG. 1 is a diagram of an example environment 100 in which systems and/or methods described herein may be implemented. As shown in FIG. 1, environment 100 may include a user device 110, a network node 120, and a network 130. Devices of environment 100 may interconnect via wired connections, wireless connections, or a combination of wired and wireless connections.

The user device 110 includes a display device 112 having a touch-enabled display screen. The user device 110 may include one or more devices capable of receiving, generating, storing, processing, and/or providing information associated with one or more rollable display panels described herein. More specifically, the user device 110 may include a communication and/or computing device, such as a mobile phone (e. g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device.

Similar to the user device 110, the network node 120 includes one or more devices capable of receiving, generating, storing, processing, and/or providing information associated with the user device 110. For example, the network node 120 may include a base station (a Node B, a gNB, and/or a 5G node B (NB), among other examples), a user equipment (UE), a relay device, a network controller, an access point, a transmit receive point (TRP), an apparatus, a device, a computing system, one or more components of any of these, and/or another processing entity configured to perform one or more aspects of the techniques described herein. For example, the network node 120 may be an aggregated base station and/or one or more components of a disaggregated base station.

The network 130 includes one or more wired and/or wireless networks. For example, the network 130 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

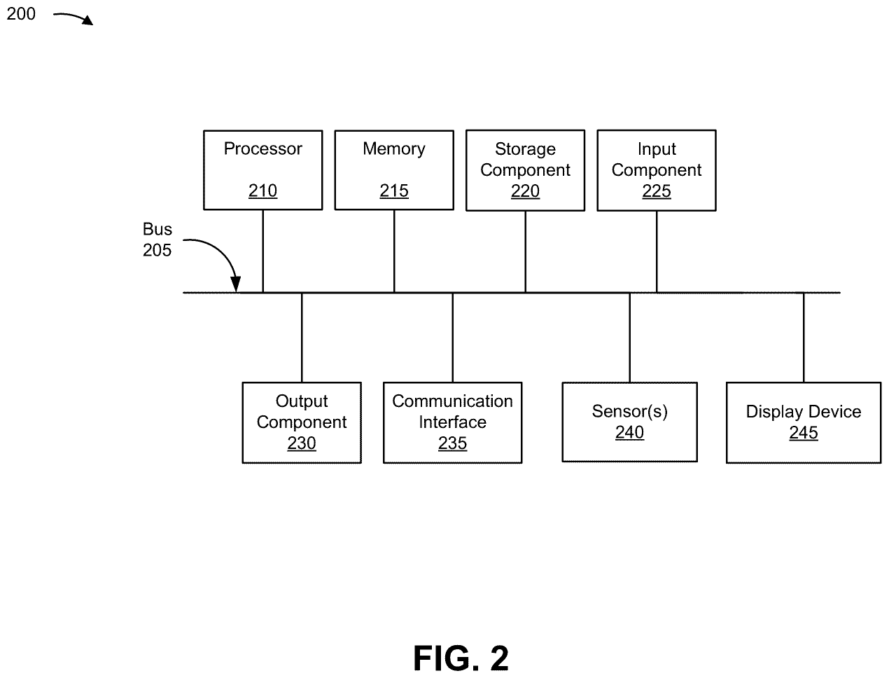

FIG. 2 is a diagram illustrating example components of a device 200, in accordance with the present disclosure. Device 200 may correspond to a user device 110 and/or a network node 120. In some aspects, the user device 110 and/or the network node 120 may include one or more devices 200 and/or one or more components of device 200. As shown in FIG. 2, device 200 may include a bus 205, a processor 210, a memory 215, a storage component 220, an input component 225, an output component 230, a communication interface 235, one or more sensors 240, and/or a display device 245.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Sensor(s) 240 includes one or more devices capable of sensing characteristics associated with device 200. Sensor(s) 240 may include one or more integrated circuits (e.g., on a packaged silicon die) and/or one or more passive components of one or more flex circuits to enable communication with one or more components of device 200.

In some aspects, a sensor 240 may include a fingerprint acquisition component. The fingerprint acquisition component may include a type of fingerprint sensor that is configured to obtain fingerprint information. In some aspects, for example, the fingerprint acquisition component may include an ultrasonic fingerprint sensor, and/or an optical fingerprint sensor, among other examples.

In some aspects, a sensor 240 may include a touch sensing component. The touch sensing component may include any type of sensor configured to obtain touch information (e.g., indicating a location of a finger press of the user on the display device 245, indicating a gesture such as a moving touch to the display device 245 (e.g., a swipe)). In some aspects, for example, the touch sensing component may include a capacitive input sensor, among other examples.

In some aspects, a sensor 240 may include a force sensing component. The force sensing component may include a force sensor, such as a strain gauge or another type of force sensor, that is configured to generate and/or obtain force information (e.g., force measurements, pressure measurements). A force measurement and/or a pressure measurement may be a measurement associated with an amount of force applied by the user to the display device 245 (e.g., by a finger press of the user's fingertip).

Display device 245 may include an output surface capable of using image projection technology (e.g., liquid crystal display (LCD), light-emitting diode (LED), organic LED (OLED), gas plasma, and/or the like) to present content in visual form. In some aspects, the display device 245 may include one or more sensors 240, such as a fingerprint sensor, a touch sensor, and/or a force sensor, among other examples. The sensors 240 included in the display device 245 may enable touch-based interactions with the display device 245 by the user. Accordingly, the display device 245 may function as an input component and an output component.

Device 200 may perform one or more processes described herein. In some aspects, for example, a “controller” of a user device may refer to any one or more of the bus 205, the processor 210, the memory 215, the storage component 220, the input component 225, the output component 230, and/or the communication interface 235. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means generating, using a fingerprint sensor (e.g., a sensor 240) of the device 200, fingerprint information associated with a finger press of a user of the device 200; means for authenticating the user in association with the fingerprint information; means for determining, in association with force information generated by a force sensor (e.g., a sensor 240) of the device 200, an amount of force applied to a display screen (e.g., the display device 245) of the device 200 by the finger press; and/or means for performing, in association with authenticating the user, an action that is associated with the amount of force applied to the display screen; or the like. In some aspects, such means may include one or more components of device 200 described in connection with FIG. 2, such as bus 205, processor 210, memory 215, storage component 220, input component 225, output component 230, communication interface 235, a sensor 240, and/or a display device 245.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

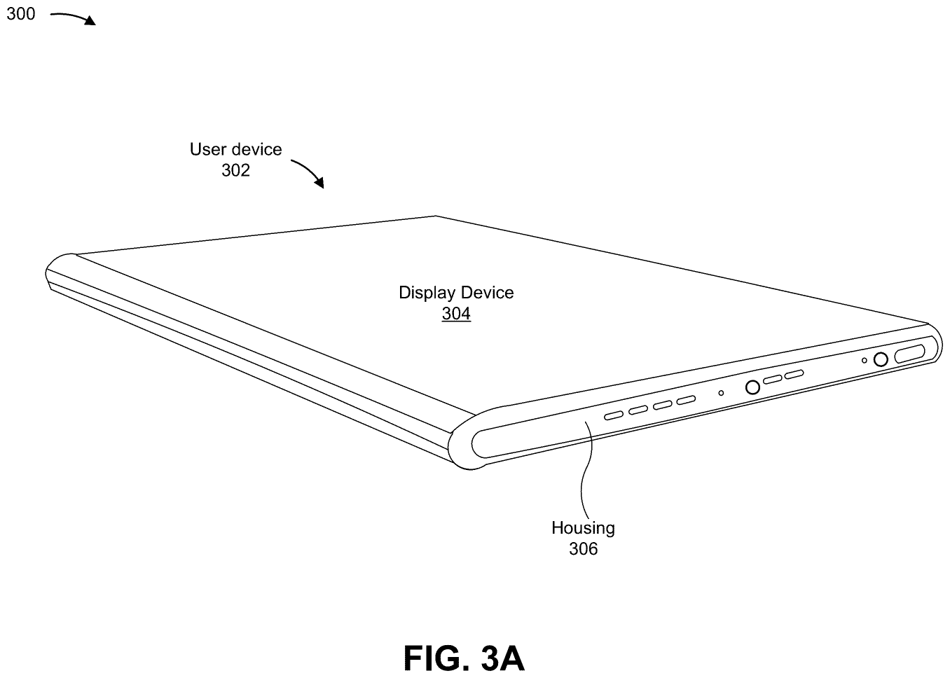

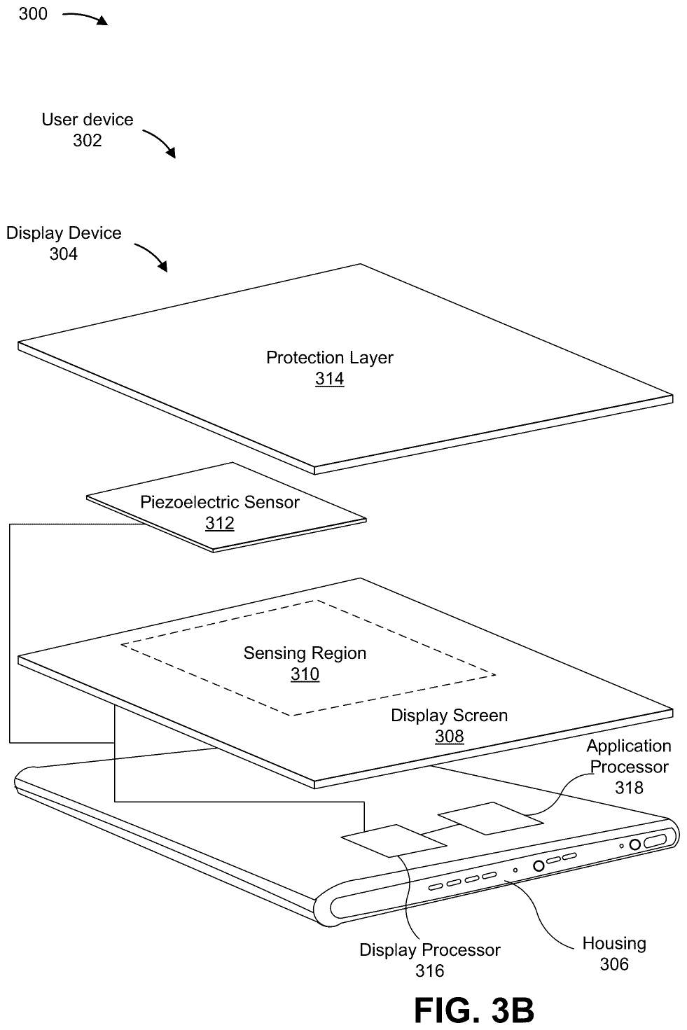

FIGS. 3A and 3B are diagrams illustrating an example 300 associated with a touch-enabled display device, in accordance with the present disclosure. As shown in FIGS. 3A and 3B, a user device 302 (e.g., a user device 110, a device 200) may include a display device 304 (e.g., display device 112, display device 245) that is coupled with a housing 306 of the user device 302. The display device 304 may be a touch-enabled display device that may be configured to detect and/or measure touch-based interactions with the display device 304. For example, the display device 304 may detect a finger press, of a user, on the display device 304. As another example, the display device 304 may generate measurements and/or information associated with the finger press, such as information identifying a time duration of the finger press, information identifying a location on the display device 304 of the finger press, information identifying a fingerprint scan of the finger press, and/or information identifying an amount of force applied to the display device 304 by the finger press, among other examples.

FIG. 3B illustrates an exploded view of the display device 304. As shown in FIG. 3B, the display device 304 may include one or more components that facilitate the touch-based functionality of the display device 304. For example, the display device 304 may include a display screen 308 that includes a sensing region 310, a piezoelectric sensor 312 above and/or over at least a portion of the display screen 308, and a protection layer 314 above and/or over the display screen 308 and the piezoelectric sensor 312.

The display screen 308 may include an LED-based display screen, an OLED-based display screen, a thin-film transistor (TFT)-based display screen, and/or another type of display screen. The display screen 308 may include a plurality of pixels for displaying visual content on the display screen 308, such as an operating system (OS), one or more applications, executed within the OS, and/or other visual content. The display screen may further include one or more capacitive touch sensors (e.g., sensors 240) configured to detect touch-based interactions with the display screen 308. The capacitive touch sensors enable a user of the user device 302 to interact with visual content displayed on the display screen 308.

The sensing region 310 of the display screen 308 may include one or more strain gauge sensors (e.g., sensors 240) that are configured to generate force information associated with an amount of force (e.g., downforce or pressure) applied to the display screen 308 by a touch-based interaction (e.g., a finger press). The force information may include a voltage, an electrical resistance, a capacitance, an inductance, and/or an electrical current, among other examples. As an example, a magnitude of an electrical resistance of a strain gauge in the sensing region 310 may depend on the amount of force applied to the display screen 308. A display processor 316 coupled with the display screen 308 may determine the amount of force based on and/or otherwise in association with the magnitude of the electrical resistance (e.g., the force information) associated with the strain gauge of the sensing region 310.

The sensing region 310 may occupy a relatively large area of the display screen 308. For example, the sensing region 310 may occupy approximately 30% of the area of the display screen 308 or greater, which enables force detection to be implemented across a large area of the display screen 308. This enables force detection to be used in conjunction with many different types of interactions with the underlying OS or applications executed within the OS.

The piezoelectric sensor 312 may be included over the sensing region 310 to enable fingerprint detection (e.g., separately or in conjunction with force detection). The piezoelectric sensor 312 and the display screen 308 may correspond to a fingerprint sensor of the user device 302. The piezoelectric sensor 312 may include a layer of piezoelectric material such as lead zirconate titanate (PZT) and/or aluminum nitride (AlN), among other examples. The piezoelectric sensor 312 may be configured as an ultrasonic-based piezoelectric sensor that is configured to generate an ultrasonic signal in association with a finger press on the display screen 308. The piezoelectric sensor 312 may generate the ultrasonic signal (e.g., an electric field, an electrical current, a voltage) based on and/or otherwise in association with pressure applied to the piezoelectric sensor 312 by the finger press. The profile of the pressure (e.g., the localized pressure in various locations under the finger press) may correspond to the ridges and grooves/valleys in the fingerprint of the user. The ultrasonic signal is then captured by the underlying display screen 308 and provided to the display processor 316. The display processor 316 may generate fingerprint information (e.g., a fingerprint scan) associated with the finger press based on and/or otherwise in association with the captured ultrasonic signal. The fingerprint scan may include a three-dimensional mapping of a fingerprint associated with the finger press.

The piezoelectric sensor 312 may occupy a relatively large area of the display screen 308. For example, the piezoelectric sensor 312 may occupy approximately 30% of the area of the display screen 308 or greater, which enables authentication to be performed across a large area of the display screen 308 and in many different device orientations of the user device 302.

The protection layer 314 may include one or more layers of glass, one or more layers of ceramic material, and/or one or more layers of silicate material, among other examples.

The display processor 316 (e.g., a processor 210) may be considered as a part of the display device 304, or alternatively may be considered separate from and coupled with the display device 304. The display processor 316 may be configured to determine a location, on the display screen 308, of a finger press or a touch-based gesture of a user of the user device 302 (e.g., based on touch information received from the display screen 308). The display processor 316 may be configured to generate fingerprint information (e.g., fingerprint scans) associated with signals received from the piezoelectric sensor 312 and/or the display screen 308. The display processor 316 may be configured to determine (e.g., based on and/or otherwise in association with force information received from the sensing region 310 or one or more force sensors in the sensing region 310) an amount force applied to the display screen 308 by a finger press of a user of the user device 302. For example, the display processor 316 may determine an amount of force applied to the display screen 308 based on and/or otherwise in association with a signal (e.g., an electrical resistance, a voltage, an electrical current, an electric field) received from one or more sensors in the sensing region 310. The display processor 316 may provide one or more signals to the display screen 308 to cause visual content to be displayed by the display screen 308.

As further shown in FIG. 3B, the user device 302 may include an application processor 318 (e.g., a processor 210). The application processor 318 may be coupled with the display processor 316. The application processor 318 may execute an OS of the user device 302 and/or may execute one or more applications (e.g., a texting application, a navigation application, a video streaming application) of the user device 302. The display processor 316 may provide information to the application processor 318 so that the application processor 318 can determine a touch-based interaction with an application and/or the OS based on and/or otherwise in association with the information provided by the display processor 316.

The application processor 318 may provide information to the display processor 316 so that the display processor 316 can cause particular visual content to be displayed by the display screen 308 based on and/or otherwise in association with the information provided by the application processor 318. In some aspects, the application processor 318 may provide information to the display processor 316 based on and/or otherwise in association with a touch-based interaction with an application and/or the OS of the user device 302.

For example, the application processor 318 may determine, based on and/or otherwise in association with the information provided by the display processor 316, a finger press of the user interacted with an application icon displayed on the display screen 308. The application processor 318 may provide information to the display processor 316 based on and/or otherwise in association with determining the finger press interacted with the application icon, where the display processor 316 may use the information to display the application, associated with the application icon, on the display screen 308.

As another example, the application processor 318 may receive, from the display processor 316, information provided indicating an amount of force applied by a finger press to the display screen 308 in a particular location of the display screen 308. The application processor 318 may provide information to the display processor 316 based on and/or otherwise in association with the information received from the display processor 316, where the display processor 316 may use the information to perform an action that is associated with the amount of force applied to the particular location of the display screen 308.

The display processor 316 and/or the application processor 318 (either individually or collectively) may be configured to perform authentication of the user of the user device 302 based on and/or otherwise in association with fingerprint information (e.g., a fingerprint scan) generated by the display processor 316. For example, the display processor 316 may provide the fingerprint information to the application processor 318. The application processor 318 may securely access a stored fingerprint scan (e.g., that is stored in a secure location on the user device 302) and compare the fingerprint information with the stored fingerprint scan. The application processor 318 may authenticate the user based on and/or otherwise in association with the comparison of the fingerprint information with the stored fingerprint scan. For example, the application processor 318 may authenticate the user based on and/or otherwise in association with determining that the fingerprint scan in the fingerprint information provided by the display processor 316 and the stored fingerprint scan are a 99% match. Alternatively, the application processor 318 may provide the stored fingerprint scan to the display processor 316, and the display processor 316 may authenticate the user based on and/or otherwise in association with the fingerprint information generated by the display processor 316.

As indicated above, FIGS. 3A and 3B are provided as an example. Other examples may differ from what is described with respect to FIGS. 3A and 3B.

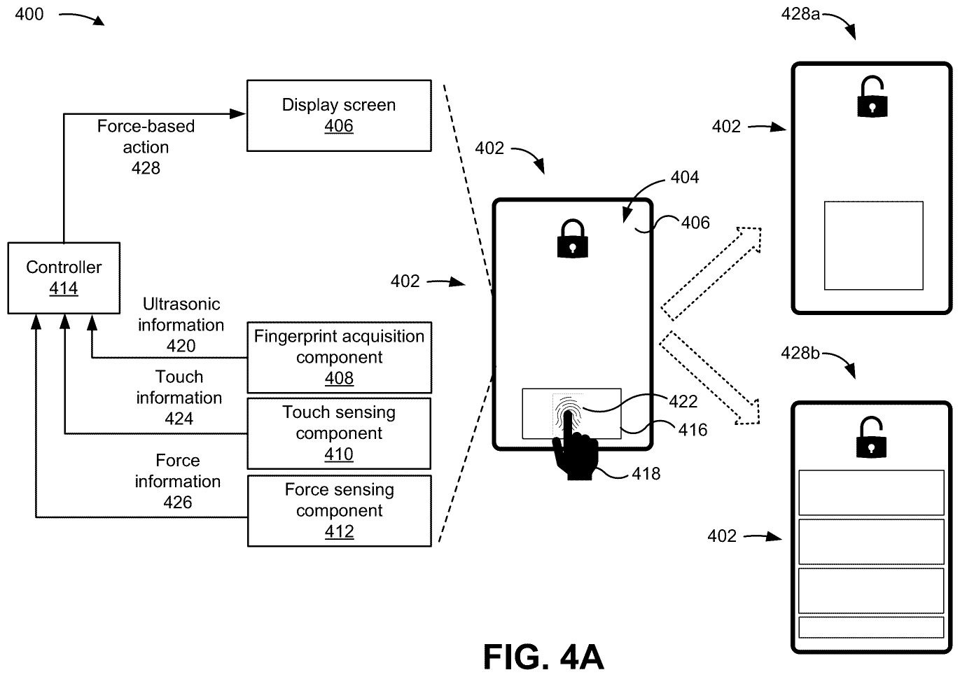

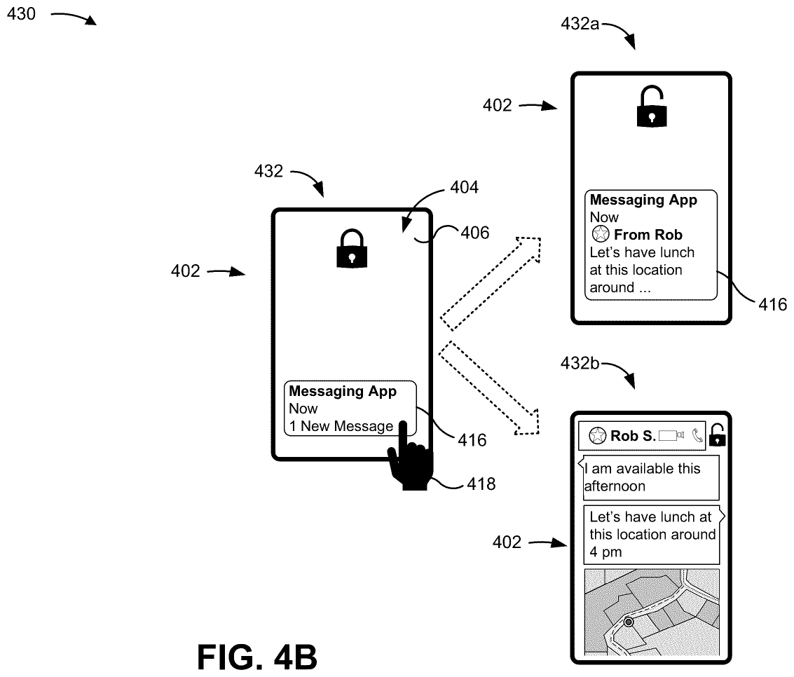

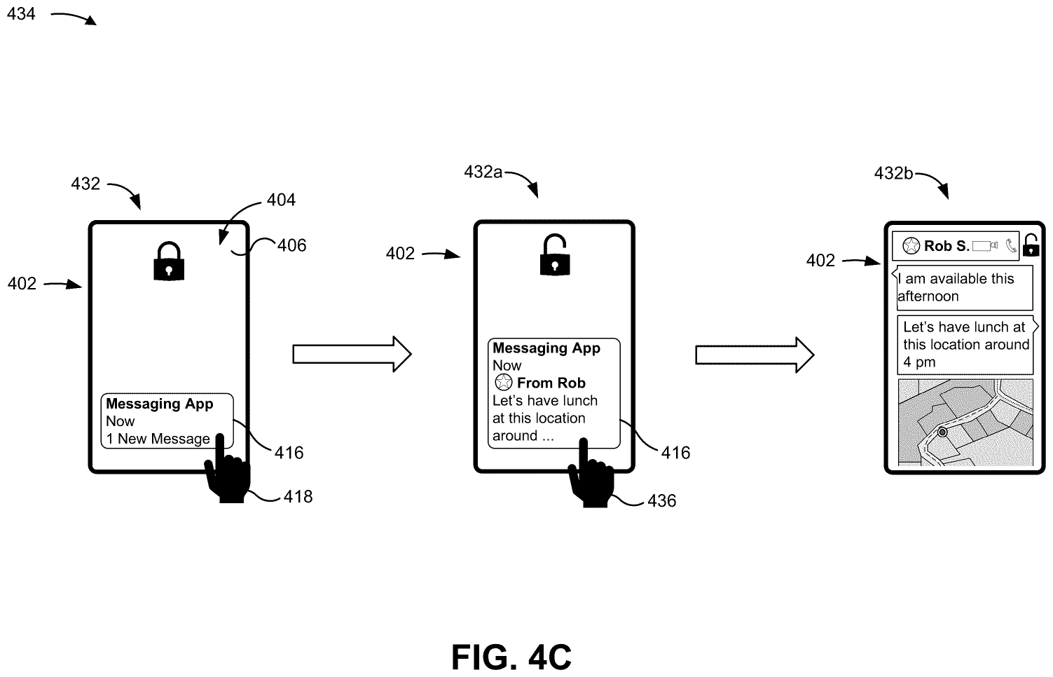

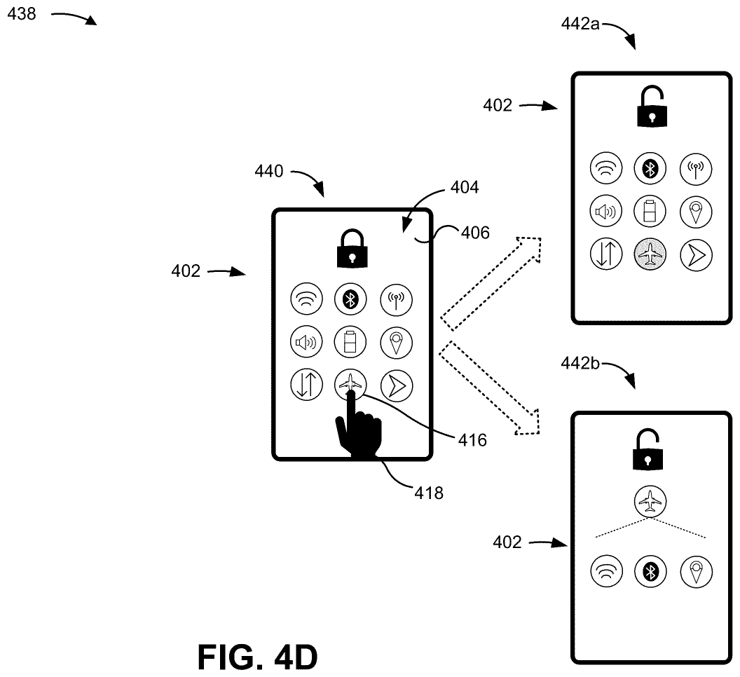

FIGS. 4A-4D are diagrams illustrating examples associated with controlling a display screen interaction based on fingerprint information and force information, in accordance with the present disclosure. As shown in an example 400 in FIG. 4A, a user device 402 (e.g., a user device 110, a device 200, a user device 302) includes a display device 404 (e.g., a display device 112, a display device 245, a display device 304) that includes a display screen 406 (e.g., a display screen 308). The user device 402 also includes a fingerprint acquisition component 408, a touch sensing component 410, a force sensing component 412, and a controller 414.

The fingerprint acquisition component 408 may include one or more sensors 240, the display screen 308, the piezoelectric sensor 312, and/or another component of the display device 404. The touch sensing component 410 may include one or more sensors 240, the display screen 308, and/or another component of the display device 404. The force sensing component 412 may include one or more sensors 240, a sensing region 310 of the display screen 308, and/or another component of the display screen 308.

The controller 414 may be referred to as a “controller of the user device 402” and/or a “controller of the display device 404.” In some aspects, the controller 414 may control one or more functions of the user device in addition to controlling functions of the display device 404. In some aspects, the controller 414 may include any one or more of the bus 205, the processor 210, the memory 215, the storage component 220, the input component 225, the output component 230, and/or the communication interface 235 depicted in FIG. 2. In some aspects, the controller 414 may include the display processor 316 and/or the application processor 318.

As shown in FIG. 4A, a user of the user device 402 may interact (e.g., using a finger or a digit of the user's hand) with a region 416 of the display screen 406 while a user interface of the user device 402 (e.g., a graphical user interface (GUI) that is presented on the display screen 406 is unauthenticated or locked. For example, the user may perform a finger press 418 in the region 416 of the display screen 406. The controller 414 may output representation information that facilitates presentation of a visual display corresponding to the region 416 on the display screen 406. The visual display may be, for example, a virtual button or a notification presented on the user interface, among other examples.

The controller 414 may obtain, by the fingerprint acquisition component 408, ultrasonic information 420 associated with the finger press 418. The ultrasonic information 420 may include an ultrasonic signal that is generated using the piezoelectric sensor 312 and/or the display screen 406 (e.g., the display screen 308) based on and/or otherwise in association with a fingerprint 422 of the finger or digit of the user used to perform the finger press 418. The controller 414 may generate, based on and/or otherwise in association with the ultrasonic information 420, fingerprint information (e.g., a fingerprint scan) associated with the finger press 418 of the user. The controller 414 may authenticate the user based on and/or otherwise in association with the fingerprint information (e.g., by comparing the fingerprint scan with a stored fingerprint scan stored in a secure location on the user device 402). The controller 414 may unlock the user interface displayed on the display screen 406 based on and/or otherwise in association with authenticating the user.

With the user authenticated, the controller 414 may obtain, by the touch sensing component 410, touch information 424 associated with the finger press 418. The touch information 424 may include a signal that is generated by the display screen 406 (e.g., the display screen 308) based on and/or otherwise in association with a location of the finger press 418 on the display screen 406. The controller 414 may determine the location of the finger press 418 based on and/or otherwise in association with the touch information 424, and may determine that the finger press 418 is in the location of the region 416. Accordingly, the controller 414 may determine, based on and/or otherwise in association with the touch information 424, that the finger press 418 is an interaction with a visual display in the region 416 on the display screen 406.

With the user authenticated, the controller 414 may obtain, by the force sensing component 412, force information 426 associated with the finger press 418. The force information 426 may include a signal generated by a strain gauge or another type of force sensor in the sensing region 310 of the display screen 406 (e.g., of the display screen 308). The force sensing component 412 may generate the force information 426 based on and/or otherwise in association with force applied to the display screen 406 by the finger press 418. The controller 414 may determine an amount of force applied to the display screen 406 by the finger press 418 based on and/or otherwise in association with the force information 426.

The controller 414 may perform a force-based action 428, may cause a force-based action 428 to be performed, and/or may output a signal that causes another component (e.g., the display screen 406) to perform a force-based action 428. The controller 414 may perform the force-based action 428 based on and/or otherwise in association with authenticating the user. The force-based action 428 may correspond to an action that is associated with the amount of force applied to the display screen 406 by the finger press 418.

For example, if the controller 414 determines that amount of force is included in a first force range, the controller 414 may perform a first force-based action 428a. If the controller 414 determines that amount of force is included in a second force range, the controller 414 may perform a second force-based action 428b.

As another example, if the controller 414 determines that the amount of force does not satisfy a force threshold, the controller 414 may perform the first force-based action 428a. If the controller 414 determines that the amount of force satisfies the force threshold, the controller 414 may perform the second force-based action 428b.

As another example, if the controller 414 determines that the amount of force satisfies a first force threshold and does not satisfy a second force threshold, the controller 414 may perform the first force-based action 428a. If the controller 414 determines that the amount of force satisfies both the first force threshold and the second force threshold, the controller 414 may perform the second force-based action 428b.

FIG. 4B illustrates an example 430 of controlling a display screen interaction with a lock screen notification based on fingerprint information and force information. As shown in FIG. 4B, and by reference number 432, the finger press 418 may interact with the region 416 of the display screen 406 in which a notification (e.g., a messaging application notification) is displayed on a lock screen of the GUI displayed on the display screen 406. The controller 414 may authenticate the user of the user device 402 based on and/or otherwise in association with the fingerprint information associated with the finger press 418.

The controller 414 may determine, based on and/or otherwise in association with the touch information 424, that the location of the finger press 418 is on the display screen 406 over the notification displayed on the lock screen of the display screen 406. The controller 414 may perform (or may cause another component of the user device 402 to) a first force-based action 432a or a second force-based action 432b based on and/or otherwise in association with an amount of force applied to the display screen 406. The first force-based action 432a may include displaying additional information in the region 416 associated with the notification. For example, the notification may indicate, on the lock screen and prior to authentication of the user, that a new message has been received. The first force-based action 432a may include displaying additional information associated with the new message, such as a snippet or a portion of the content of the message. The second force-based action 432b may opening and displaying the messaging application on the display screen 406 so that the user can view the full message history, the full content of the new message, and/or respond to the new message. In this way, the amount of force applied to the display screen 406 by the finger press 418, in combination with authentication of the user, provides the user with a secure manner in which the user can selectively preview the new message or enter the messaging application, which increases the security of the user's information and increases the security of the user device 402.

FIG. 4C illustrates an example 434 of controlling a display screen interaction with a lock screen notification based on fingerprint information and force information. The example 434 is similar to the example 430, except that the user may perform another finger press 436 after the first force-based action 432a is performed to initiate the second force-based action 432b. The controller 414 may determine an amount of force applied to the display screen 406 by the finger press 436, may determine that the location of the finger press 436 is over the notification (e.g., after the notification has been expanded to show additional information), and may perform (or cause another component of the user device 402 to perform) the second force-based action 432b based on and/or otherwise in association with the amount of force applied to the display screen 406 by the finger press 436. For example, the controller 414 may determine that the amount of force applied to the display screen 406 by the finger press 436 satisfies a force threshold and/or is included in a force range associated with the second force-based action 432b, and may perform (or cause another component of the user device 402 to perform) the second force-based action 432b based on and/or otherwise in association with the amount of force applied to the display screen 406 by the finger press 436 satisfying the force threshold and/or being included in the force range associated with the second force-based action 432b. In this way, the amount of force applied to the display screen 406 by the finger presses 418 and 436, in combination with authentication of the user, provides the user with a secure manner in which the user can first preview the new message, and then enter the messaging application after previewing the new message, which increases the security of the user's information and increases the security of the user device 402. Accordingly, controlling the interactions with the display screen 406 based on fingerprint information and force information enables intermediate actions to be performed while maintain security over user information.

FIG. 4D illustrates an example 438 of controlling a display screen interaction with a user interface settings based on fingerprint information and force information. As shown in FIG. 4D, and by reference number 440, the finger press 418 may interact with the region 416 of the display screen 406 in which a graphical icon associated with a user interface setting (e.g., an airplane mode setting) is displayed on the display screen 406. The controller 414 may authenticate the user of the user device 402 based on and/or otherwise in association with the fingerprint information associated with the finger press 418.

The controller 414 may determine, based on and/or otherwise in association with the touch information 424, that the location of the finger press 418 is on the display screen 406 over the graphical icon associated with the user interface setting displayed on the display screen 406. The controller 414 may perform (or may cause another component of the user device 402 to) a first force-based action 442a or a second force-based action 442b based on and/or otherwise in association with an amount of force applied to the display screen 406. The first force-based action 442a may include modifying one or more parameters associated with the user interface setting. For example, if the finger press 418 enables airplane mode, the first force-based action 442a may include modifying a Wi-Fi parameter (e.g., disabling Wi-Fi functionality on the user device 402), modifying a location services parameter (e.g., disabling location services functionality on the user device 402), and modifying a Bluetooth parameter (e.g., disabling Bluetooth functionality on the user device 402).

The second force-based action 442b may include opening and displaying a detailed view of the user interface setting. The detailed view may include a display of the graphical icons associated with the one or more parameters of the user interface setting. For example, if the second force-based action 442b may include displaying a detailed view of the airplane mode user interface setting, which may include a display of the graphical icons for enabling/disabling Wi-Fi functionality, enabling/disabling location services, and/or enabling/disabling Bluetooth, among other examples. This provides the user with more granular control over the airplane mode user interface setting parameters. This enables the user to, for example, disable Wi-Fi and Bluetooth, but still retain location services enabled.

Other force-based actions may be performed based on and/or otherwise in association with an amount of force applied to the display screen 406 by a finger press of the user of the user device 402. For example, a first amount of force applied to the display screen 406 by a finger press may correspond to decreasing a speaker volume of the user device 402, and/or a second amount of force applied to the display screen 406 by a finger press may correspond to increasing a speaker volume of the user device 402. As another example, a first amount of force applied to the display screen 406 by a finger press may correspond to saving a digital image to a photo library of the user device 402, and/or a second amount of force applied to the display screen 406 by a finger press may correspond to copying the digital image. As another example, a first amount of force applied to the display screen 406 by a finger press may correspond to activating/deactivating a flashlight function of the user device 402, and/or a second amount of force applied to the display screen 406 by a finger press may correspond to displaying a brightness setting for the flashlight function. As another example, a first amount of force applied to the display screen 406 by a finger press may correspond to displaying additional information associated with a new email notification on a lock screen, and/or a second amount of force applied to the display screen 406 by a finger press may correspond to displaying available actions associated with the new email notification (e.g., replying to the email, forwarding the email, deleting the email).

As indicated above, FIGS. 4A-4D are provided as examples. Other examples may differ from what is described with respect to FIGS. 4A-4D.

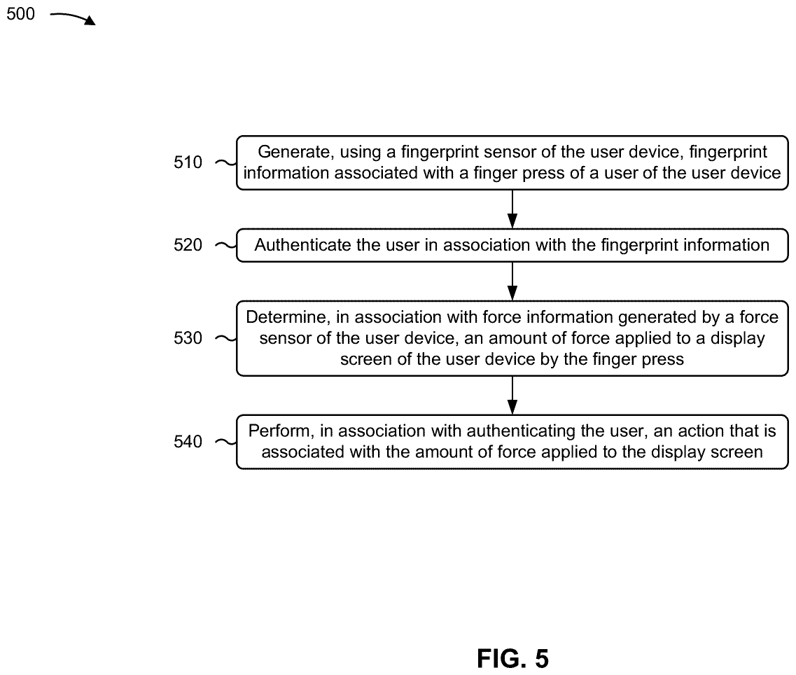

FIG. 5 is a flowchart of an example process 500 associated with controlling a display screen interaction based on fingerprint information and force information. In some implementations, one or more process blocks of FIG. 5 are performed by a user device (e.g., user device 110, device 200, user device 302, user device 402). Additionally, or alternatively, one or more process blocks of FIG. 5 may be performed by one or more components of device 200, such as processor 210, memory 215, storage component 220, input component 225, output component 230, communication interface 235, sensor(s) 240, and/or display device 245.

As shown in FIG. 5, process 500 may include generating, using a fingerprint sensor of the user device, fingerprint information associated with a finger press of a user of the user device (block 510). For example, the user device may generate, using a fingerprint sensor of the user device, fingerprint information associated with a finger press of a user of the user device, as described above.

As further shown in FIG. 5, process 500 may include authenticating the user in association with the fingerprint information (block 520). For example, the user device may authenticate the user in association with the fingerprint information, as described above.

As further shown in FIG. 5, process 500 may include determining, in association with force information generated by a force sensor of the user device, an amount of force applied to a display screen of the user device by the finger press (block 530). For example, the user device may determine, in association with force information generated by a force sensor of the user device, an amount of force applied to a display screen of the user device by the finger press, as described above.

As further shown in FIG. 5, process 500 may include performing, in association with authenticating the user, an action that is associated with the amount of force applied to the display screen (block 540). For example, the user device may perform, in association with authenticating the user, an action that is associated with the amount of force applied to the display screen, as described above.

Process 500 may include additional implementations, such as any single implementation or any combination of implementations described below and/or in connection with one or more other processes described elsewhere herein.

In a first implementation, the fingerprint sensor comprises an ultrasonic-based piezoelectric sensor, and generating the fingerprint information comprises generating, using the ultrasonic-based piezoelectric sensor, a fingerprint scan in association with the finger press.

In a second implementation, alone or in combination with the first implementation, the force sensor comprises a strain gauge sensor, and process 500 includes generating the force information using the strain gauge sensor, wherein the force information comprises an electrical resistance, and wherein determining the amount of force applied to the display screen comprises determining the amount of force applied to the display screen in association with the electrical resistance.

In a third implementation, alone or in combination with one or more of the first and second implementations, a location of the finger press on the display screen is over a notification displayed on a lock screen of the display screen, the amount of force applied to the display screen is a first amount of force, and the action comprises a first action of displaying additional information associated with the notification.

In a fourth implementation, alone or in combination with one or more of the first through third implementations, a second amount of force applied to the display screen is associated with a second action, and the second action comprises displaying an application associated with the notification on the display screen.

In a fifth implementation, alone or in combination with one or more of the first through fourth implementations, a location of the finger press on the display screen is over a graphical icon associated with a user interface setting displayed on the display screen, the amount of force applied to the display screen is a first amount of force, and the action comprises a first action of modifying a plurality of parameters associated with the user interface setting.

In a sixth implementation, alone or in combination with one or more of the first through fifth implementations, a second amount of force applied to the display screen is associated with a second action, and the second action comprises displaying each of the plurality of parameters so that each of the plurality of parameters can be individually modified in association with further interaction with the display screen.

In a seventh implementation, alone or in combination with one or more of the first through sixth implementations, performing the action that is associated with the amount of force applied to the display screen comprises performing the action in association with the amount of force applied to the display screen satisfying a force threshold, wherein the action is associated with the force threshold.

In an eighth implementation, alone or in combination with one or more of the first through seventh implementations, performing the action that is associated with the amount of force applied to the display screen comprises performing the action in association with the amount of force applied to the display screen being included within a force range, wherein the action is associated with the force range.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method performed by a user device, comprising: generating, using a fingerprint sensor of the user device, fingerprint information associated with a finger press of a user of the user device; authenticating the user in association with the fingerprint information; determining, in association with force information generated by a force sensor of the user device, an amount of force applied to a display screen of the user device by the finger press; and performing, in association with authenticating the user, an action that is associated with the amount of force applied to the display screen.

Aspect 2: The method of Aspect 1, wherein the fingerprint sensor comprises an ultrasonic-based piezoelectric sensor; and wherein generating the fingerprint information comprises: generating, using the ultrasonic-based piezoelectric sensor, a fingerprint scan in association with the finger press.

Aspect 3: The method of any of Aspects 1-2, wherein the force sensor comprises a strain gauge sensor; wherein the method further comprises: generating the force information using the strain gauge sensor, wherein the force information comprises an electrical resistance; and wherein determining the amount of force applied to the display screen comprises: determining the amount of force applied to the display screen in association with the electrical resistance.

Aspect 4: The method of any of Aspects 1-3, wherein a location of the finger press on the display screen is over a notification displayed on a lock screen of the display screen; wherein the amount of force applied to the display screen is a first amount of force; and wherein the action comprises a first action of displaying additional information associated with the notification.

Aspect 5: The method of Aspect 4, wherein a second amount of force applied to the display screen is associated with a second action; and wherein the second action comprises displaying an application associated with the notification on the display screen.

Aspect 6: The method of any of Aspects 1-5, wherein a location of the finger press on the display screen is over a graphical icon associated with a user interface setting displayed on the display screen; wherein the amount of force applied to the display screen is a first amount of force; and wherein the action comprises a first action of modifying a plurality of parameters associated with the user interface setting.

Aspect 7: The method of Aspect 6, wherein a second amount of force applied to the display screen is associated with a second action; and wherein the second action comprises displaying each of the plurality of parameters so that each of the plurality of parameters can be individually modified in association with further interaction with the display screen.

Aspect 8: The method of any of Aspects 1-7, wherein performing the action that is associated with the amount of force applied to the display screen comprises: performing the action in association with the amount of force applied to the display screen satisfying a force threshold, wherein the action is associated with the force threshold.

Aspect 9: The method of any of Aspects 1-8, wherein performing the action that is associated with the amount of force applied to the display screen comprises: performing the action in association with the amount of force applied to the display screen being included within a force range, wherein the action is associated with the force range.

Aspect 10: A system configured to perform one or more operations recited in one or more of Aspects 1-9.

Aspect 11: An apparatus comprising means for performing one or more operations recited in one or more of Aspects 1-9.

Aspect 12: A non-transitory computer-readable medium storing a set of instructions, the set of instructions comprising one or more instructions that, when executed by a device, cause the device to perform one or more operations recited in one or more of Aspects 1-9.

Aspect 13: A computer program product comprising instructions or code for executing one or more operations recited in one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user device, comprising:
a memory; and
one or more processors, coupled to the memory, configured to:
generate, using a fingerprint sensor of the user device, fingerprint information associated with a finger press of a user of the user device;
authenticate the user in association with the fingerprint information;
determine, in association with force information generated by a force sensor of the user device, an amount of force applied to a display screen of the user device by the finger press; and
perform, in association with authenticating the user, an action that is associated with the amount of force applied to the display screen.

2. The user device of claim 1, wherein the fingerprint sensor comprises an ultrasonic-based piezoelectric sensor; and
wherein the one or more processors, to generate the fingerprint information, are configured to:
generate, using the ultrasonic-based piezoelectric sensor, a fingerprint scan in association with the finger press.

3. The user device of claim 1, wherein the force sensor comprises a strain gauge sensor;
wherein the one or more processors are further configured to:
generate the force information using the strain gauge sensor,
wherein the force information comprises an electrical resistance; and
wherein the one or more processors, to determine the amount of force applied to the display screen, are configured to:
determine the amount of force applied to the display screen in association with the electrical resistance.

4. The user device of claim 1, wherein a location of the finger press on the display screen is over a notification displayed on a lock screen of the display screen;
wherein the amount of force applied to the display screen is a first amount of force; and
wherein the action comprises a first action of displaying additional information associated with the notification.

5. The user device of claim 4, wherein a second amount of force applied to the display screen is associated with a second action; and
wherein the second action comprises displaying an application associated with the notification on the display screen.

6. The user device of claim 1, wherein a location of the finger press on the display screen is over a graphical icon associated with a user interface setting displayed on the display screen;
wherein the amount of force applied to the display screen is a first amount of force; and
wherein the action comprises a first action of modifying a plurality of parameters associated with the user interface setting.

7. The user device of claim 6, wherein a second amount of force applied to the display screen is associated with a second action; and
wherein the second action comprises displaying each of the plurality of parameters so that each of the plurality of parameters can be individually modified in association with further interaction with the display screen.

8. The user device of claim 1, wherein the one or more processors, to perform the action that is associated with the amount of force applied to the display screen, are configured to:
perform the action in association with the amount of force applied to the display screen satisfying a force threshold,
wherein the action is associated with the force threshold.

9. The user device of claim 1, wherein the one or more processors, to perform the action that is associated with the amount of force applied to the display screen, are configured to:
perform the action in association with the amount of force applied to the display screen being included within a force range,
wherein the action is associated with the force range.

10. A method performed by a user device, comprising:
generating, using a fingerprint sensor of the user device, fingerprint information associated with a finger press of a user of the user device;
authenticating the user in association with the fingerprint information;
determining, in association with force information generated by a force sensor of the user device, an amount of force applied to a display screen of the user device by the finger press; and
performing, in association with authenticating the user, an action that is associated with the amount of force applied to the display screen.

11. The method of claim 10, wherein the fingerprint sensor comprises an ultrasonic-based piezoelectric sensor; and
wherein generating the fingerprint information comprises:
generating, using the ultrasonic-based piezoelectric sensor, a fingerprint scan in association with the finger press.

12. The method of claim 10, wherein the force sensor comprises a strain gauge sensor;
wherein the method further comprises:
generating the force information using the strain gauge sensor, wherein the force information comprises an electrical resistance; and
wherein determining the amount of force applied to the display screen comprises:
determining the amount of force applied to the display screen in association with the electrical resistance.

13. The method of claim 10, wherein a location of the finger press on the display screen is over a notification displayed on a lock screen of the display screen;
wherein the amount of force applied to the display screen is a first amount of force; and
wherein the action comprises a first action of displaying additional information associated with the notification.

14. The method of claim 13, wherein a second amount of force applied to the display screen is associated with a second action; and
wherein the second action comprises displaying an application associated with the notification on the display screen.

15. The method of claim 10, wherein a location of the finger press on the display screen is over a graphical icon associated with a user interface setting displayed on the display screen;
wherein the amount of force applied to the display screen is a first amount of force; and
wherein the action comprises a first action of modifying a plurality of parameters associated with the user interface setting.

16. The method of claim 15, wherein a second amount of force applied to the display screen is associated with a second action; and
wherein the second action comprises displaying each of the plurality of parameters so that each of the plurality of parameters can be individually modified in association with further interaction with the display screen.

17. The method of claim 10, wherein performing the action that is associated with the amount of force applied to the display screen comprises:
performing the action in association with the amount of force applied to the display screen satisfying a force threshold,
wherein the action is associated with the force threshold.

18. The method of claim 10, wherein performing the action that is associated with the amount of force applied to the display screen comprises:
performing the action in association with the amount of force applied to the display screen being included within a force range,
wherein the action is associated with the force range.

19. A non-transitory computer-readable medium storing a set of instructions, the set of instructions comprising:
one or more instructions that, when executed by one or more processors of a user device, cause the user device to:
generate, using a fingerprint sensor of the user device, fingerprint information associated with a finger press of a user of the user device;
authenticate the user in association with the fingerprint information;
determine, in association with force information generated by a force sensor of the user device, an amount of force applied to a display screen of the user device by the finger press; and
perform, in association with authenticating the user, an action that is associated with the amount of force applied to the display screen.

20. The non-transitory computer-readable medium of claim 19, wherein the fingerprint sensor comprises an ultrasonic-based piezoelectric sensor; and
wherein the one or more instructions, that cause the user device to generate the fingerprint information, cause the user device to:
generate, using the ultrasonic-based piezoelectric sensor, a fingerprint scan in association with the finger press.

21. The non-transitory computer-readable medium of claim 19, wherein the force sensor comprises a strain gauge sensor;
wherein the one or more instructions further cause the user device to:
generate the force information using the strain gauge sensor,
wherein the force information comprises an electrical resistance; and
wherein the one or more instructions, that cause the user device to determine the amount of force applied to the display screen, cause the user device to:
determine the amount of force applied to the display screen in association with the electrical resistance.

22. The non-transitory computer-readable medium of claim 19, wherein a location of the finger press on the display screen is over a notification displayed on a lock screen of the display screen;
wherein the amount of force applied to the display screen is a first amount of force; and
wherein the action comprises a first action of displaying additional information associated with the notification.

23. The non-transitory computer-readable medium of claim 22, wherein a second amount of force applied to the display screen is associated with a second action; and
wherein the one or more instructions further cause the user device to display an application associated with the notification on the display screen.

24. The non-transitory computer-readable medium of claim 19, wherein a location of the finger press on the display screen is over a graphical icon associated with a user interface setting displayed on the display screen;
wherein the amount of force applied to the display screen is a first amount of force; and
wherein the action comprises a first action of modifying a plurality of parameters associated with the user interface setting.

25. An apparatus, comprising:
means for generating, using a fingerprint sensor of the apparatus, fingerprint information associated with a finger press of a user of the apparatus;
means for authenticating the user in association with the fingerprint information;
means for determining, in association with force information generated by a force sensor of the apparatus, an amount of force applied to a display screen of the apparatus by the finger press; and
means for performing, in association with authenticating the user, an action that is associated with the amount of force applied to the display screen.

26. The apparatus of claim 25, wherein the fingerprint sensor comprises an ultrasonic-based piezoelectric sensor; and
wherein the means for generating the fingerprint information comprises:
means for generating, using the ultrasonic-based piezoelectric sensor, a fingerprint scan in association with the finger press.

27. The apparatus of claim 25, wherein the force sensor comprises a strain gauge sensor;
wherein the apparatus further comprises:
means for generating the force information using the strain gauge sensor, wherein the force information comprises an electrical resistance; and
wherein the means for determining the amount of force applied to the display screen comprises:
means for determining the amount of force applied to the display screen in association with the electrical resistance.

28. The apparatus of claim 25, wherein a location of the finger press on the display screen is over a notification displayed on a lock screen of the display screen;
wherein the amount of force applied to the display screen is a first amount of force; and
wherein the action comprises a first action of displaying additional information associated with the notification.

29. The apparatus of claim 28, wherein a second amount of force applied to the display screen is associated with a second action; and
further comprising means for displaying an application associated with the notification on the display screen.

30. The apparatus of claim 25, wherein a location of the finger press on the display screen is over a graphical icon associated with a user interface setting displayed on the display screen;
wherein the amount of force applied to the display screen is a first amount of force; and
wherein the action comprises a first action of modifying a plurality of parameters associated with the user interface setting.
